(19) United States
(12) Patent Application Publication
(10) Pub. No.: US 2026/0119246 A1
(43) Pub. Date: Apr. 30, 2026

(54) DEVICE AND METHOD FOR IMPROVING APPLICATION PERFORMANCE BASED ON BLOCK SAMPLES

(71) Applicant: UIF (UNIVERSITY INDUSTRY FOUNDATION), YONSEI UNIVERSITY, Seoul (KR)

(72) Inventor: Jinkyu Jeong, Seoul (KR)

(73) Assignee: UIF (UNIVERSITY INDUSTRY FOUNDATION), YONSEI UNIVERSITY, Seoul (KR)

(21) Appl. No.: 18/933,709

(22) Filed: Oct. 31, 2024

(30) Foreign Application Priority Data
Oct. 24, 2024 (KR) 10-2024-0146875

(51) Int. Cl. G06F 9/50; G06F 11/34

(52) U.S. Cl. CPC G06F 9/5027; G06F 11/3409; G06F 2209/5018

(57) ABSTRACT

The present invention relates to a blocked sample-based application speedup device and method, and the device includes a blocked sample generation unit that samples events occurring regardless of whether a thread is in a CPU execution state or a blocked state, to generate blocked samples, a first profiler that analyzes an on-CPU event and an off-CPU event of the blocked samples in an integrated manner and identifies a performance bottleneck of an application, a second profiler that analyzes the interdependence between the on-CPU event and the off-CPU event and predicts speedup for the performance bottleneck through virtual optimization of a specific event, and an optimization strategy generation unit that generates an optimization strategy for the specific event.

### CROSS-REFERENCE TO RELATED APPLICATION

This application claims under 35 U.S.C. § 119(a) the benefit of Korean Patent Application No. 10-2014-0146875 filed on Oct. 24, 2024, the entire contents of which is incorporated herein by reference.

### TECHNICAL FIELD

The present invention relates to application speedup technology, and more specifically, to a device and method for improving application performance based on blocked samples capable of performing virtual speedup by profiling a causal relationship between an on-CPU event and an off-CPU event in an integrated manner.

### BACKGROUND

Application profiling includes analyzing two types of events, that is, an on-CPU event and an off-CPU event. The on-CPU event refers to an instruction that is executed on a CPU. The instruction includes operation (ALU or FPU) and memory access (load or store) instructions, and do not include a section where a thread is blocked while the instruction is being performed. The Off-CPU event refers to a section where a thread is blocked while instructions are executed. The on-CPU event and the off-CPU event are complemental. The off-CPU event includes sections in which a thread is not actually being executed on the CPU, such as storage blocking input and output, synchronization between threads, and waiting due to CPU scheduling.

Causal profiling is a profiling technique for confirming an optimization effect without actually optimizing an application.

A state-of-the-art causal profiler (hereinafter referred to as ‘COZ’) performs causal profiling based on virtual speedup. The virtual speedup intentionally injects a delay into other threads that are being executed at the same time in order to reproduce the same effects as actual optimization of a speedup prediction target task. When the application execution ends, a speedup prediction value of a task is calculated through a difference between an amount of the intentional delay and a degree to which an actual application is slowed down.

When there is a dependency between threads, the intentional delay injected when the virtual speedup is performed may cause an error in speedup prediction results. This is because a double delay may be injected into a thread waiting for tasks of other threads to be completed. An existing COZ may correctly perform speedup prediction by exempting threads waiting due to the presence of a dependency from a delay accumulated during a blocked section in order to solve such a situation.

The COZ is a causal profiler that is useful in that the COZ specifies points at which optimization is required for parallel program code. In order to perform virtual speedup, the COZ collects application execution information such as an instruction pointer (IP) and a call chain and periodically confirms the information to determine whether the speedup prediction target task is being performed. When the target task is being performed, an intentional delay is applied to other threads that are executed at the same time.

However, the COZ has a limitation in that the COZ cannot predict speedup for off-CPU events because the COZ depends on sampling of application execution information using a Linux perf subsystem. In the sampling, IPs and call chains are periodically collected, but when a thread being executed is blocked due to a system call, the thread is disabled and execution information cannot be collected during a block section. Therefore, the COZ cannot provide useful results for an application where there are both an on-CPU event and an off-CPU event because the off-CPU event cannot be included in a virtual speedup target due to absence of off-CPU event information.

### PRIOR ART DOCUMENT

### Patent document

Korean Patent Publication No. 10-2016-0003502 (Jan. 11, 2016)

### DESCRIPTION

### Problem to be Solved

An embodiment of the present invention provides a blocked sample-based application speedup device and method capable of performing virtual speedup for integrated on-CPU and off-CPU events by performing blocked sample-based application sampling.

Another embodiment of the present invention provides a blocked sample-based application speedup device and method capable of processing a delay for virtual speedup of an off-CPU event immediately after the off-CPU event is completed, so that a thread can be correctly exempted from the delay by dependency handling.

### Solution

In embodiments, a blocked sample-based application speedup device includes a blocked sample generation unit configured to sample events occurring regardless of whether a thread is in a CPU execution state or a blocked state, to generate blocked samples; a first profiler configured to analyze an on-CPU event and an off-CPU event of the blocked samples in an integrated manner and identify a performance bottleneck of an application; a second profiler configured to analyze the interdependence between the on-CPU event and the off-CPU event and predict speedup for the performance bottleneck through virtual optimization of a specific event; and an optimization strategy generation unit configured to generate an optimization strategy for the specific event.

The blocked sample generation unit may sample an event even in a case where the thread is in the blocked state, the case being a state where the thread is not executed on the CPU due to an I/O wait, a synchronization wait, or a scheduling wait.

The blocked sample generation unit may confirm a state of the thread through a timer at points in time when the thread is scheduled out and scheduled in, sample the blocked samples, and record a blocking event.

The blocked sample generation unit may record a weight indicating the number of repetitions to reduce duplication of blocking events, and group and process the blocking events with the same attribute as a single blocking event.

The blocked sample generation unit may store, in the blocking event, an instruction address (IP) of an instruction executed immediately before the thread is blocked when the thread is scheduled out, a call chain indicating a stack trace of functions called by the thread, a type in which a type of blocking event is recorded, and a blocking timestamp indicating a point in time when the thread has been blocked, and the type of blocking event may correspond to one of the I/O wait, the synchronization wait, and the scheduling wait.

The blocked sample generation unit may store a wake-up timestamp in the blocking event in order to trace a waiting time and waiting reason of the thread when the thread wakes up.

The blocked sample generation unit may store a schedule-in timestamp in the blocking event to calculate a total duration (T_{blocked}) and a scheduling waiting time (T_{sched}) of the blocking event when the thread is scheduled in.

The first profiler may determine the on-CPU event and the off-CPU event in a blocking event and analyze overhead information occupied by each event during application execution. The first profiler may perform classification into subclasses according to I/O wait, synchronization wait, or scheduling wait through analysis of the overhead information, and determine a performance bottleneck of the subclasses to identify a performance bottleneck of the application.

The second profiler may perform causal relationship analysis between the on-CPU event and the off-CPU event and predict speedup by virtually accelerating a specific event through a virtual speedup technique.

The optimization strategy generation unit may generate an optimization strategy for code causing a bottleneck in the specific event.

In embodiments, a blocked sample-based application speedup method is a blocked sample-based application speedup method performed in a blocked sample-based application speedup device, and includes a blocked sample generation step of sampling events occurring regardless of whether a thread is in a CPU execution state or a blocked state, to generate blocked samples; a first profiling step of analyzing an on-CPU event and an off-CPU event of the blocked samples in an integrated manner and identifying a performance bottleneck of an application; a second profiling step of analyzing the interdependence between the on-CPU event and the off-CPU event and predicting speedup for the performance bottleneck through virtual optimization of a specific event; and an optimization strategy generation step of generating an optimization strategy for the specific event.

### Effect

The disclosed technology can have the following effects. However, since this does not mean that a specific embodiment should include all of the following effects or only the following effects, the scope of the disclosed technology should not be understood as being limited thereby.

With the blocked sample-based application speedup device and method according to an embodiment of the present invention, it is possible to perform virtual speedup for integrated on-CPU and off-CPU events by performing blocked sample-based application sampling.

With the blocked sample-based application speedup device and method according to an embodiment of the present invention, it is possible to process a delay for virtual speedup of an off-CPU event immediately after the off-CPU event is completed, so that a thread can be correctly exempted from the delay by dependency handling.

Therefore, according to the present invention, the off-CPU event can be included as a virtual speedup target, the thread can be correctly exempted from the delay by dependency processing, and the performance optimization of the application can be achieved not only through application code optimization but also through performance optimization of a system code associated with application execution or a device (a storage device, an accelerator, or the like) utilized for the execution.

### BRIEF DESCRIPTION OF THE DRAWINGS

FIG. 1 is a diagram illustrating a configuration of a computer system.

FIG. 2 is a diagram illustrating an application speedup device according to the present invention.

FIG. 3 is a flowchart illustrating a blocked sample-based application speedup method according to the present invention.

FIG. 4 is a diagram illustrating an embodiment of a blocked sample generation process according to the present invention.

FIG. 5 is a diagram illustrating an embodiment of a first profiling result according to the present invention.

FIG. 6 is a diagram illustrating an embodiment in which second profiling is performed according to the present invention.

FIG. 7 is a diagram illustrating an embodiment of a second profiling result according to the present invention.

FIGS. 8 and 9 are diagrams illustrating experimental results regarding a blocked sample-based application speedup method according to the present invention.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

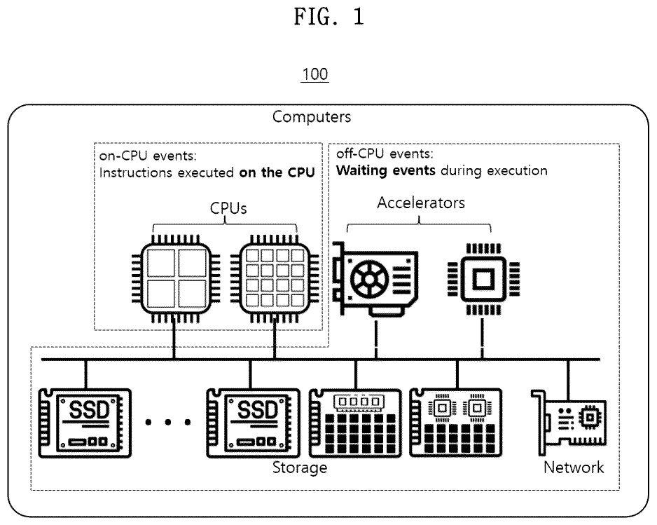

FIG. 1 is a diagram illustrating a configuration of a computer system.

Referring to FIG. 1, with the rapid development of components, events to be executed outside a CPU, that is, in an off-CPU such as an accelerator, a storage device, or a network device have become more diverse in a computer system 100. An on-CPU event means a command that is executed inside the CPU. An off-CPU event waits while a command is executed in the CPU.

Such a computing environment makes an operation of an application more complex, thereby diversifying a bottleneck phenomenon.

The present invention proposes a technique for simultaneously sampling events inside and outside a CPU through a sampling technique called blocked samples so that the two events can be simultaneously profiled and a performance bottleneck phenomenon can be identified, and analyzing the events in an integrated manner through a statistical-based profiler and a causal relationship-based profiler to identify a performance bottleneck and predict optimized speedup.

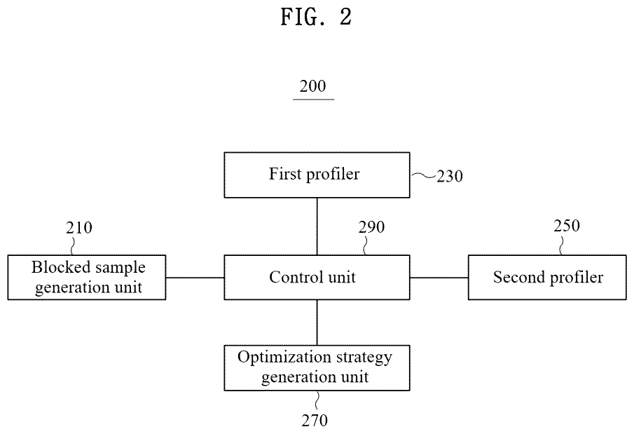

FIG. 2 is a diagram illustrating an application speedup device according to the present invention.

Referring to FIG. 2, the application speedup device 200 may perform a blocked sample-based application speedup method according to the present invention to generate an application performance optimization strategy. To this end, the application speedup device 200 may be implemented by including a plurality of functional configurations inside the computer system 100. Specifically, the application speedup device 200 may include a blocked sample generation unit 210, a first profiler 230, a second profiler 250, an optimization strategy generation unit 270, and a control unit 290.

In this case, the application speedup device 200 does not have to include all of the functional configurations at the same time, and may be implemented without some of the configurations or by selectively including some or all of the configurations according to each embodiment. Hereinafter, an operation of each functional configuration will be described in detail.

The blocked sample generation unit 210 may sample an event that occurs regardless of whether the thread is in a CPU execution state or a blocked state to generate blocked samples. Here, the blocked state means a state where the thread is not executed on the CPU and is waiting. The blocked sample generation unit 110 may sample an event even in a case where the thread is in the blocked state, which is a state where the thread is not executed on the CPU due to an I/O wait, a synchronization wait, or a scheduling wait. The I/O wait is a state where a thread waits for I/O tasks such as file read/write or network communication to be completed. The synchronization wait refers to a state where other threads wait while resources are locked in a situation in which synchronization is required for safe use of the resources when several threads use shared resources. The scheduling wait refers to a waiting state occurring when a scheduler of an operating system has not allocated CPU resources to execute threads, and a thread should wait when other threads executable on the CPU are executed first.

The blocked sample generation unit 210 may confirm the state of the thread through a timer at points in time when the thread is scheduled out and scheduled in, sample the blocked samples, and record the blocking event. The schedule-out refers to a process in which a thread that is currently being executed on the CPU is no longer executed and proceeds to a waiting state, and the schedule-out occurs when the scheduler of the operating system removes the thread from the CPU and executes another thread. The schedule-in refers to a process in which a waiting thread is selected to be executed on the CPU again, and the thread is released from the waiting state and processes tasks on the CPU. The blocked sample generation unit 210 may check the state of the thread at a point in time of schedule-in to confirm whether the thread is being executed on the CPU or in a blocked state, sample the blocked state when the thread is in the blocked state, and record a reason why the thread is in the blocked state (for example, I/O waiting, synchronization waiting, or scheduling waiting) and how long this state has lasted as a blocking event.

The blocked sample generation unit 210 may record a weight indicating the number of repetitions to reduce duplication of blocking events, and group and process the blocking events with the same attribute as a single blocking event. The blocking event is an event that occurs when the thread is not executed on the CPU and is in the waiting state, and a length of the blocked thread may be small or large. When the blocked state is maintained for a long time and this is recorded as an individual event, duplicate data may be excessively generated, which increases an amount of resources required for analysis. Here, the same attribute means the same cause and situation of the blocking event. The blocked sample generation unit 210 can record the weight when the blocking event is long, thereby maintaining statistical information for the number of times the event occurs while preventing unnecessary duplication.

Further, the blocked sample generation unit 210 may store, in the blocking event, an instruction address (IP) of an instruction executed immediately before the thread is blocked when the thread is scheduled out, a call chain indicating a stack trace of functions called by the thread, a type in which a type of blocking event is recorded, and a blocking timestamp indicating a point in time when the thread has been blocked. The type of blocking event may correspond to one of I/O wait, synchronization wait, or scheduling wait. The blocked sample generation unit 210 may ascertain a reason why the thread is not executed on the CPU at a point in time when the thread is scheduled out, and record a state thereof. Information recorded at this time may be used to analyze change in the state of the thread. Here, the instruction address is a memory address of an instruction that the thread has last executed on the CPU and may be used to trace at which part the thread has been switched to the blocked state, and in particular, it is possible to ascertain a position at which the performance bottleneck occurs, by confirming whether the thread has been switched to the waiting state while which instruction of a program is being executed. The call chain refers to a path (stack trace) through which a function currently being executed by the thread is called, and a function call path in which the blocking event has occurred when the blocking event occurs can be ascertained through the stack trace. For example, assuming that function A calls function B and function B calls function C again, the stack trace becomes A→B→C. That is, the blocking event may store an instruction address (a position of an instruction executed immediately before blocking), a call chain (a function call path where blocking has occurred), a blocking type (one of I/O wait, synchronization wait, and scheduling wait), and a timestamp (a point in time when blocking has occurred). The information stored in the blocking event may be utilized for performance analysis.

The blocked sample generation unit 210 may store a wake-up timestamp in the blocking event in order to trace the waiting time and waiting reason of the thread when the thread wakes up. Further, the blocked sample generation unit 210 may store a schedule-in timestamp in the blocking event to calculate a total duration T_{blocked} and a scheduling waiting time T_{sched} of the blocking event when the thread is scheduled in.

The first profiler 230 may analyze the on-CPU event and the off-CPU event of the blocked samples in an integrated manner and identify the performance bottleneck of the application. The first profiler 230 may determine the on-CPU event and the off-CPU event in the blocking event and analyze overhead information that each event occupies during the execution of the application. The balance between an execution time on the CPU and the waiting time may be important for performance of the application. For example, usage during too much time on the CPU may mean that the calculation is complicated, and when there are too many off-CPU events, this can mean that I/O waiting or resource waiting becomes a performance bottleneck. The first profiler 230 analyzes blocking event records to determine an on-CPU event and an off-CPU event occurring in the application, and analyzes an overhead occupied by each event during application execution to identify a performance bottleneck. Here, an on-CPU overhead refers to a delay that occurs due to excessive CPU usage while the thread is being executed on the CPU. An off-CPU overhead refers to a delay that occurs while the thread is in a blocked state.

The first profiler 230 may perform classification into subclasses according to I/O wait, synchronization wait, or scheduling wait through analysis of the overhead information, and determine a performance bottleneck of the subclasses to identify a performance bottleneck of the application. The first profiler 230 may analyze the overhead information to identify types of blocking events having an influence on application performance degradation and classify the types into subclasses. The first profiler 230 may analyze the waiting time belonging to each subclass to confirm which of the I/O wait, the synchronization wait, and the scheduling wait is a cause of the performance bottleneck.

The second profiler 250 may analyze interdependence between the on-CPU event and the off-CPU event to predict speedup for the performance bottleneck through optimization of the specific event. The second profiler 250 may perform causal relationship analysis between the on-CPU event and the off-CPU event and predict speedup by virtually accelerating the specific event through a virtual speedup technique. The second profiler 250 may explore various optimization schemes, such as upgrading I/O devices or adding CPU cores, by analyzing the interaction of the on-CPU events as well as the off-CPU events. Further, the second profiler 250 can explore various optimization strategies by predicting virtual speedup for not only specific lines of code but also off-CPU subclasses. A virtual speedup technique is a way to virtually experiment how the performance will change when the specific lines of code are optimized. The second profiler 250 may predict performance change similar to when code lines are actually optimized, by applying the virtual speedup technique to not only the on-CPU event but also the off-CPU event to manage dependencies between threads and process delay time injection for virtual speedup.

With the application speedup device 200, it is possible to accurately and efficiently identify and optimize a performance bottleneck phenomenon of a complex application through the first profiler 230 and the second profiler 250.

The optimization strategy generation unit 270 may generate an optimization strategy for a specific event. The optimization strategy generation unit 270 may generate an optimization strategy for code that causes a bottleneck in the specific event. In an embodiment, the optimization strategy generation unit 270 may predict a performance bottleneck point of the application, and speedup when the bottleneck is optimized, through analysis results of the second profiler 250, thereby establishing a speedup optimization strategy.

The control unit 290 may control an overall operation of the application speedup device 200, and manage a control flow or data flow between the blocked sample generation unit 210, the first profiler 230, the second profiler 250, and the optimization strategy generation unit 270.

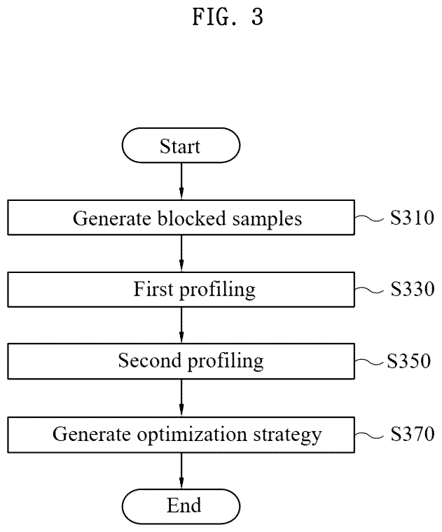

FIG. 3 is a flowchart illustrating a blocked sample-based application speedup method according to the present invention.

Referring to FIG. 3, the application speedup device 200 can process a series of operation steps for performing the blocked sample-based application speedup method. Specifically, the application speedup device 200 may sample events occurring regardless of whether the thread is in a CPU execution state or a blocked state through the blocked sample generation unit 210 to generate blocked samples (step S310). The application speedup device 200 may analyze the on-CPU event and the off-CPU event of the blocked samples in an integrated manner and identify the performance bottleneck of the application through the first profiler 230 (step S330).

Further, the application speedup device 200 may analyze the interdependence between the on-CPU event and the off-CPU event to predict speedup for the performance bottleneck through optimization of the specific event using the second profiler 250 (step S350). The application speedup device 200 may generate an optimization strategy for the specific event through the optimization strategy generation unit 270 (step S370).

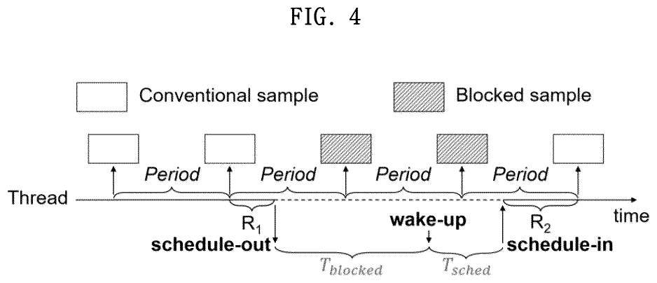

FIG. 4 is a diagram illustrating an embodiment of a blocked sample generation process according to the present invention.

Referring to FIG. 4, the application speedup device 200 may perform an operation of generating blocked samples by sampling events that occur regardless of whether the thread is in a CPU execution state or a blocked state. For the blocked sample, information on blocking events of threads, such as I/O completion wait, synchronization wait (for example, a mutex or condition variable), and CPU scheduling wait is captured. An existing CPU event sampling is thread-oriented (for example, task-clock in a Linux perf subsystem), and in event-based sampling, samples of thread context (for example, an IP and a call chain) are periodically collected when the thread executes instructions on the CPU. As illustrated in FIG. 4, when the thread is blocked, sampling is suspended until the thread wakes up and resumes the execution. Samples missing while the thread is blocked are complemented with the blocked samples so that execution context during a blocking period is provided, unlike the existing CPU event sampling.

Each blocked sample includes four attributes such as an instruction address (IP) of an instruction executed immediately before the thread is blocked to track an off-CPU event, a call chain, a weight, and a type. The IP is a return address (for example, schedule or io_schedule in Linux) at which a CPU scheduler is actually called. The call chain is a stack trace of functions called by the thread. The blocking event may include several blocked samples with the same attributes (for example, the same IP or call chain). The application speedup device 200 may encode the number of repetitions in a weight field to save a space and time when processing the blocked samples.

The application speedup device 200 records a subclass of thread blocking together with a timestamp indicating the start of an off-CPU period (blocking timestamp) when the thread is scheduled out, and records a timestamp indicating the end of the off-CPU period (wake-up timestamp) when the thread is woken up. When the thread is scheduled in, the application speedup device 200 records the schedule-in timestamp and calculates a blocking time T_{blocked} and a CPU scheduling waiting time T_{sched}, as illustrated in FIG. 4. In the case of threads that are executable but remain in an execution queue due to the CPU contention, the off-CPU period belongs to a scheduling subclass of the blocked samples because there is no wake-up timestamp. In a schedule-in function, when a blocking period overlaps one or more sampling points in time, a new sample is generated. This sample includes properties of an IP, a call chain, a weight, and a type.

In the case of FIG. 4, the total duration T_{blocked} and the scheduling waiting time T_{sched} of the blocking events, which are two off-CPU events, include two sampling points. Therefore, two blocked samples, one for blocking at one of the two sampling points and the other for scheduling at the other of the two sampling points, are collected. When the off-CPU period does not overlap with any sampling point, no blocked sample is collected. Since only a timestamp task is performed at three hook points, it is possible to minimize an overhead of collection of the blocked samples even when the off-CPU event occurs frequently.

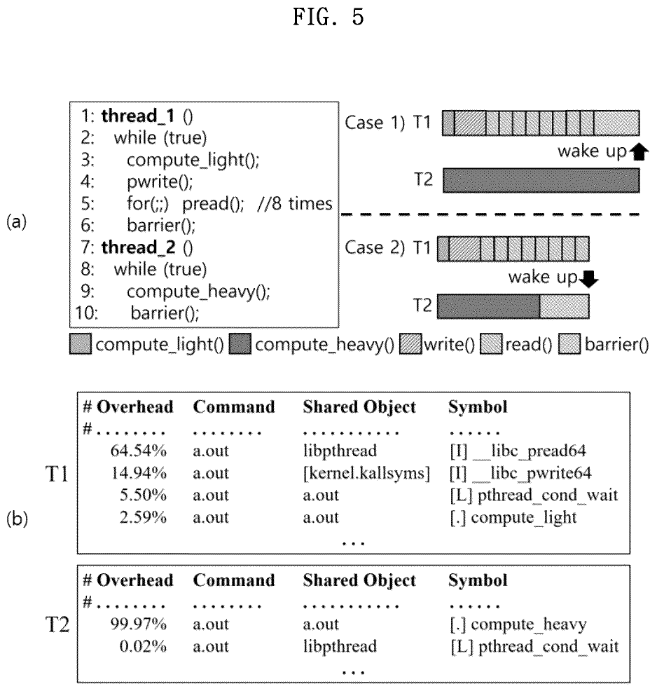

FIG. 5 is a diagram illustrating an embodiment of the first profiling result according to the present invention.

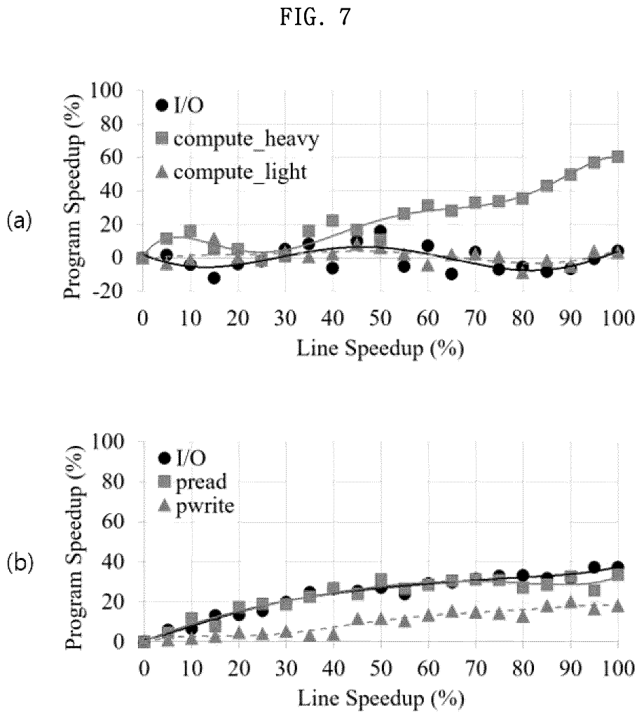

Referring to FIG. 5, the application speedup device 200 may perform first profiling for analyzing the on-CPU event and the off-CPU event of the blocked samples in an integrated manner and identifying a performance bottleneck of the application. The application speedup device 200 may profile the application using sampling-based profiling and provide statistics for sampling results through the first profiler 230. The first profiler 230 is an extended version of a Linux perf tool for supporting blocked samples, and will be hereinafter referred to as bperf for convenience of description. bperf may connect and disconnect sampling-based profiling at any time while a program is being executed, similar to perf. Basically, a way of processing the blocked samples does not have a great difference from an existing way of processing on-CPU samples. The samples are classified based on an IP and a call chain, and statistics such as overhead parts, function symbols, and object files are reported using such information as in (b) of FIG. 7. (b) of FIG. 7 shows profiling results for case 1 in (a) of FIG. 7 using bperf. bperf may allow the on-CPU event and the off-CPU event to be analyzed in an integrated manner so that an overhead of various events can be more accurately understood.

In the case of (b) of FIG. 7, each of threads T1 and T2 is connected to a shared object and a function symbol related to a command. In thread 1 T1, pread causes the largest overhead, followed by pwrite, and pthread_cond_wait takes up the third largest overhead. In thread 2 T2, compute_heavy takes up all execution time of the thread. In other words, bperf may analyze the on-CPU event and the off-CPU event in an integrated manner to clearly ascertain which task causes the performance bottleneck in each thread. bperf can help analyze application performance by providing statistics of overhead, function call, and related files generated in each thread. Using bperf, an interaction with the blocking events within an operating system kernel can be deeply analyzed, and a performance optimization guideline can be provided based on the profiling results.

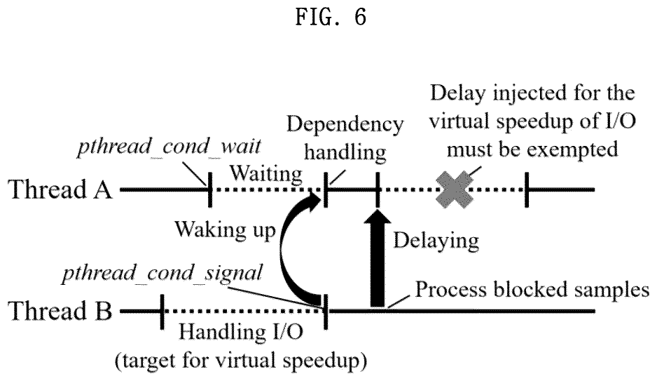

FIG. 6 is a diagram illustrating an embodiment in which second profiling is performed according to the present invention, and FIG. 7 is a diagram illustrating an embodiment of a second profiling result according to the present invention.

Referring to FIGS. 6 and 7, the application speedup device 200 may perform second profiling for analyzing the interdependence between the on-CPU event and the off-CPU event and predicting the speedup for the performance bottleneck through the optimization of the specific event. With the application speedup device 200, it is possible to accurately identify an interaction between the on-CPU event and the off-CPU event by using symbol-level information obtained from the blocked sample and predict the speedup through the virtual speedup using the second profiler 250. Since the blocked samples are processed after the blocking event, that is, the I/O task, is completed, a problem of delay injection into the thread that has a dependency on the blocking event due to the processing of the blocked samples may occur. As illustrated in FIG. 6, if thread A is waiting for the completion of a blocking I/O task of thread B and the I/O task is a virtual speedup target task, dependency handling is processed when the waiting thread A wakes up. In this case, a delay for virtual speedup of the off-CPU event may be injected after thread A wakes up, which may cause a double delay problem. The second profiler 250 of the application speedup device 200 processes the delay for virtual speedup of the off-CPU event immediately after the off-CPU event is completed. That is, in FIG. 6, a delay that should be injected before thread B wakes up thread A is processed immediately, so that thread A can be correctly exempted from the delay by dependency handling.

(a) and (b) of FIG. 7 shows virtual speedup results for cases 1 and 2 in (a) of FIG. 5 as profiling results of the second profiler 250. (a) and (b) of FIG. 7 show that actual speedup can be achieved by optimizing compute_heavy in case 1 and optimizing an I/O task, especially pread, in Case 2. Further, the virtual speedup results show that the actual speedup is limited by a point where a critical path moves.

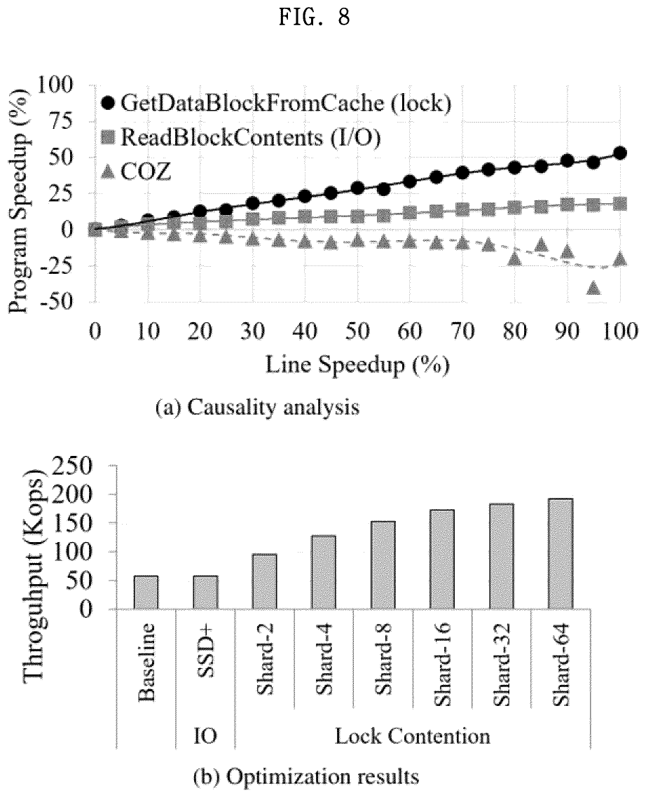

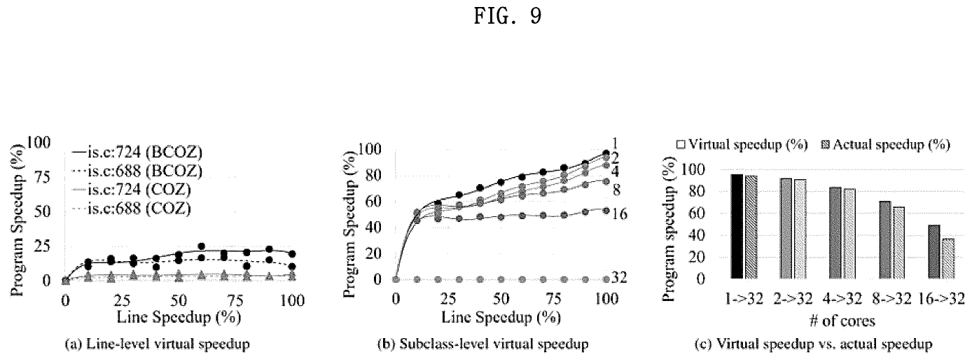

FIGS. 8 and 9 are diagrams illustrating experimental results regarding a blocked sample-based application speedup method according to the present invention.

Referring to FIGS. 8 and 9, the application speedup device 200 may perform the blocked sample-based application speedup method according to the present invention. Specifically, the experiment was performed on a machine equipped with an Intel Xeon Gold 5218 CPU (2.30 GHz and 16 physical cores), a 375 GB DDR4 DRAM, and a flash-based SSD (PM983) capable of providing a performance of an I/O task of up to 540K per second (IOPS). FIG. 8 shows results of causal profiling based on virtual speedup using an existing method (COZ) and the method proposed in the present invention for read-only execution of Prefix Dist, which is a Facebook open source workload. (a) of FIG. 8 shows a relationship between program speedup and line speedup, and shows virtual speedup results using the existing method (dotted line) and the proposed method (solid line). In the results, two tasks, GetDataBlockFromCache and ReadBlockContents, are identified as a bottleneck phenomenon. A cache lookup task is an actual bottleneck point because workers compete for lock of a block cache. As illustrated in (a) of FIG. 8, the proposed method shows a speedup of up to 60% when the cache lookup task is optimized, and shows a speedup of up to 20% when a block reading I/O task is optimized. Although the two tasks involve the off-CPU event, the existing method does not show any virtual speedup results for the two tasks since the existing method cannot reflect the off-CPU event in the profiling. That is, with a causal profiling method proposed in the present invention, it is possible to analyze speedup in consideration of off-CPU events such as the cache lookup and the block reading.

In order to verify the virtual speedup results, optimizations for the two tasks were performed. First, the flash-based SSD was replaced with a faster SSD that provides up to 1,500K IOPS performance. This optimization is indicated as SSD+. As can be seen in (b) of FIG. 8, there was no speedup in SSD+. This is because lock contention is a main bottleneck. In the second optimization, sharding that divides the block cache into several shards was applied. This is indicated as Shard-N (where N is the number of shards). With shard-N, the performance was improved, as can be seen in (b) of FIG. 8. This is because, when the number of shards is larger, lock contention decreases, resulting in higher throughput. It can be seen that this trend also appears in (a) of FIG. 8.

In the case of (a) of FIG. 9, in the existing method (COZ), a likelihood of speedup was slightly estimated, while in the proposed method (BCOZ), potential speedup was predicted when the code lines are optimized, as profiling results of main operation code lines using the existing method (COZ) and the proposed method (BCOZ) when the number of CPU cores is limited to one. In a state where the CPU contention is high (for example, 32 threads and one core), the off-CPU event frequently occurs because the thread is frequently scheduled out. In this case, with the proposed method (BCOZ), it is possible to predict an optimization opportunity in which performance can be improved when the off-CPU event of the scheduling subclass is eliminated.

In the case of (b) of FIG. 9, program speedup predicted in a highest CPU contention state (when only one core is used) reaches a maximum value as profiling results for the virtual speedup at a scheduling subclass level as the number of cores increases from 1 to 32. However, it was confirmed that, as the number of cores increases, the CPU contention decreases and a speedup effect also decreases.

In the case of (c) of FIG. 9, virtual and actual program speedup is shown when the number of cores changes from X to 32, that is, when switching occurs from the state where the CPU contention is high to a state where there is no CPU contention. It was shown that the actual speedup is consistent with the speedup predicted by the proposed method. This result confirms that it is important to accurately profile the off-CPU event in highly parallelized workloads, and that the proposed method provides useful profiling results by utilizing the blocked samples.

With a blocked sample-based profiling technique proposed in the present invention, it is possible to identify a bottleneck phenomenon of the application in the same dimension by integrating the on-CPU event and the off-CPU event. Further, according to the present invention, it is possible to identify a bottleneck phenomenon related to I/O and synchronization tasks that have not been identified in existing profiling by using a profiler for identifying an application bottleneck based on an event execution time by utilizing the blocked samples and a causal profiler for providing virtual speedup for an off-CPU event, and to optimize such tasks through virtual speedup.

Although the preferred embodiments of the present invention have been described above, it will be understood by those skilled in the art that the present invention can be variously modified and changed without departing from the scope and spirit of the present invention described in the claims below.
[National Research Development Project supporting the Present Invention]
[Project Serial No] 1711201093
[Project No] 00321688
[Department] Ministry of Science and ICT
[Project management (Professional) Institute] National Research Foundation of Korea
[Research Project Name] Establishment of Ultra-High-Performance Computing SW Ecosystem
[Research Task Name] Development of Korean Exascale Application SW Development Environment (KEASE) Framework
[Project Performing Institute] Soongsil University Industry-University Cooperation Foundation
[Research Period] 2023.11.01˜2024.04.30
[National Research Development Project supporting the Present Invention]
[Project Serial No] 2710006677
[Project No] RS-2020-II201361
[Department] Ministry of Science and ICT
[Project management (Professional) Institute] Institute of Information & Communications Technology Planning & Evaluation
[Research Project Name] Nurturing ICT and Broadcasting Innovation Talents
[Research Task Name] Artificial Intelligence Graduate School Support Project (Yonsei University)
[Project Performing Institute] University Industry Foundation, Yonsei University
[Research period] 2024.01.01˜2024.12.31
[National Research Development Project supporting the Present Invention]
[Project Serial No] 2710007311
[Project No] 2021-0-00773
[Department] Ministry of Science and ICT
[Project management (Professional) Institute] Institute of Information and Communications Technology Planning and Evaluation
[Research Project Name] Core Computing Technology
[Research Task Name] Edge-friendly operating system for edge microdata center
[Project Performing Institute] Sungkyunkwan University Industry-University Cooperation Foundation
[Research Period] 2021.04.01˜2024.12.31

### DETAILED DESCRIPTION OF MAIN ELEMENTS

100: Computer system
200: Application speedup device
210: Blocked sample generation unit
230: First profiler
250: Second profiler
270: Optimization strategy generation unit
290: Control unit

1. A blocked sample-based application speedup device comprising:
a blocked sample generation unit configured to sample events occurring regardless of whether a thread is in a CPU execution state or a blocked state, to generate blocked samples;
a first profiler configured to analyze an on-CPU event and an off-CPU event of the blocked samples in an integrated manner and identify a performance bottleneck of an application;
a second profiler configured to analyze the interdependence between the on-CPU event and the off-CPU event and predict speedup for the performance bottleneck through virtual optimization of a specific event; and
an optimization strategy generation unit configured to generate an optimization strategy for the specific event.

2. The blocked sample-based application speedup device of claim 1, wherein the blocked sample generation unit samples the events even in a case where the thread is in the blocked state, the case being a state where the thread is not executed on the CPU due to an I/O wait, a synchronization wait, or a scheduling wait.

3. The blocked sample-based application speedup device of claim 2, wherein the blocked sample generation unit confirms a state of the thread through a timer at points in time when the thread is scheduled out and scheduled in, samples the blocked samples, and records a blocking event.

4. The blocked sample-based application speedup device of claim 3, wherein the blocked sample generation unit records a weight indicating the number of repetitions to reduce duplication of blocking events, and groups and processes the blocking events with the same attribute as a single blocking event.

5. The blocked sample-based application speedup device of claim 3, wherein
the blocked sample generation unit stores, in the blocking event, an instruction address (IP) of an instruction executed immediately before the thread is blocked when the thread is scheduled out, a call chain indicating a stack trace of functions called by the thread, a type in which a type of blocking event is recorded, and a blocking timestamp indicating a point in time when the thread has been blocked, and
the type of blocking event corresponds to one of the I/O wait, the synchronization wait, and the scheduling wait.

6. The blocked sample-based application speedup device of claim 5, wherein the blocked sample generation unit stores a wake-up timestamp in the blocking event in order to trace a waiting time and waiting reason of the thread when the thread wakes up.

7. The blocked sample-based application speedup device of claim 6, wherein the blocked sample generation unit stores a schedule-in timestamp in the blocking event to calculate a total duration (T_{blocked}) and a scheduling waiting time (T_{sched}) of the blocking event when the thread is scheduled in.

8. The blocked sample-based application speedup device of claim 1, wherein the first profiler determines the on-CPU event and the off-CPU event in a blocking event and analyzes overhead information occupied by each event during application execution.

9. The blocked sample-based application speedup device of claim 8, wherein the first profiler performs classification into subclasses according to I/O wait, synchronization wait, or scheduling wait through analysis of the overhead information, and determines a performance bottleneck of the subclasses to identify a performance bottleneck of the application.

10. The blocked sample-based application speedup device of claim 1, wherein the second profiler performs causal relationship analysis between the on-CPU event and the off-CPU event and predicts speedup by virtually accelerating a specific event through a virtual speedup technique.

11. The blocked sample-based application speedup device of claim 1, wherein the optimization strategy generation unit generates an optimization strategy for code causing a bottleneck in the specific event.

12. A blocked sample-based application speedup method performed in a blocked sample-based application speedup device, the blocked sample-based application speedup method comprising:
a blocked sample generation step of sampling events occurring regardless of whether a thread is in a CPU execution state or a blocked state, to generate blocked samples;
a first profiling step of analyzing an on-CPU event and an off-CPU event of the blocked samples in an integrated manner and identifying a performance bottleneck of an application;
a second profiling step of analyzing the interdependence between the on-CPU event and the off-CPU event and predicting speedup for the performance bottleneck through virtual optimization of a specific event; and
an optimization strategy generation step of generating an optimization strategy for the specific event.
